(19) United States
(12) Patent Application Publication
(10) Pub. No.: US 2023/0074551 A1
(43) Pub. Date: Mar. 9, 2023

(54) DEVICE FAILURE PREDICTION BASED ON AUTOENCODERS

(71) Applicant: Hewlett-Packard Development Company, L.P., Spring, TX (US)

(72) Inventors: Joel Berain, Boise, ID (US); Devin Scott Uehling, Vancouver, WA (US); Anton Wiranata, Boise, ID (US)

(73) Assignee: Hewlett-Packard Development Company, L.P., Spring, TX (US)

(21) Appl. No.: 17/799,713

(22) PCT Filed: Mar. 23, 2020
(86) PCT No.: PCT/US2020/024302

§ 371 Date: Aug. 15, 2022

(51) Int. Cl. G05B 23/02

(52) U.S. Cl. CPC G05B 23/0283; G05B 23/027; G05B 23/0281

(57) ABSTRACT

An apparatus may include a processor that may be caused to access a plurality of measurements of a device. The processor may provide the plurality of measurements as an input to an autoencoder, the autoencoder being trained based on measurements of devices in working condition and access an output of the autoencoder, the output comprising a reconstruction of the input based on decoding an encoded version of the input. The processor may further be caused to determine whether the device will fail based on the output.

### BACKGROUND

A device may be prone wear-and-tear or other issues that may lead to failure, leading to downtime of the device. For example, a printer motor may fail over time—in many instances without warning—leading to downtime of the printer motor (and a printer that includes the printer motor).

### BRIEF DESCRIPTION OF THE DRAWINGS

Features of the present disclosure may be illustrated by way of example and not limited in the following figure(s), in which like numerals indicate like elements, in which:

FIG. 1 depicts a block diagram of an example apparatus that determines whether a device will fail based on autoencoders;

FIGS. 2A and 2B each respectively depict an example architecture of an apparatus to determine whether a device will fail based on autoencoders;

FIG. 3 depicts an example of measurement data of a device;

FIG. 4 depicts an example of a schematic representation of an autoencoder;

FIG. 5A depicts an example of a precision distribution plot for predictions of whether a device will fail based on autoencoders;

FIG. 5B depicts an example of a recall distribution plot for predictions of whether a device will fail based on autoencoders;

FIG. 6 depicts a flow diagram of an example method of determining whether a device will fail based on autoencoders; and

FIG. 7 depicts a block diagram of an example non-transitory machine-readable storage medium of training an autoencoder to predict whether a device will fail.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” may be intended to denote at least one of a particular element. As used herein, the term “includes” means includes but not limited to, the term “including” means including but not limited to. The term “based on” means based at least in part on.

Disclosed herein are improved apparatuses, methods, and machine-readable media that may detect device failures by training deep learning autoencoders to recognize signs of failures. Autoencoders are a type of neural network that recognize certain patterns from training data. An autoencoder may use encoders that decompress the input training data into a lesser dimensional representation of the input. Using decoders, the autoencoder may attempt to recreate the input from the decompressed representation, guided by certain reference points encoded by the encoders. If the training data includes measurements of working condition devices, then the autoencoder may take measurements of other working condition devices as input and be able to decompress and reconstruct such inputs. If not, then the other working condition devices may be predicted to fail.

In a particular example, the disclosure may be used to predict motor failures in printer devices. In this example, the training data to train the autoencoders may include measurements of motors in working condition. Such measurements may include voltage readings of the motor and/or other measurement data. For example, voltage consumption by the motors over time may become unstable or otherwise exhibit anomalous behaviours as they start to fail. When measurements such as voltage readings of a motor of a printer being tested deviate from the working conditions, the output of the autoencoder may show deviation from an expected output, indicating that a failure may occur. The disclosure may be used to predict failure of other types of devices (other than printer motors) in printers or other devices in apparatuses that are not printers so long as measurements of such devices exhibit measurement patterns that may correlate with failure.

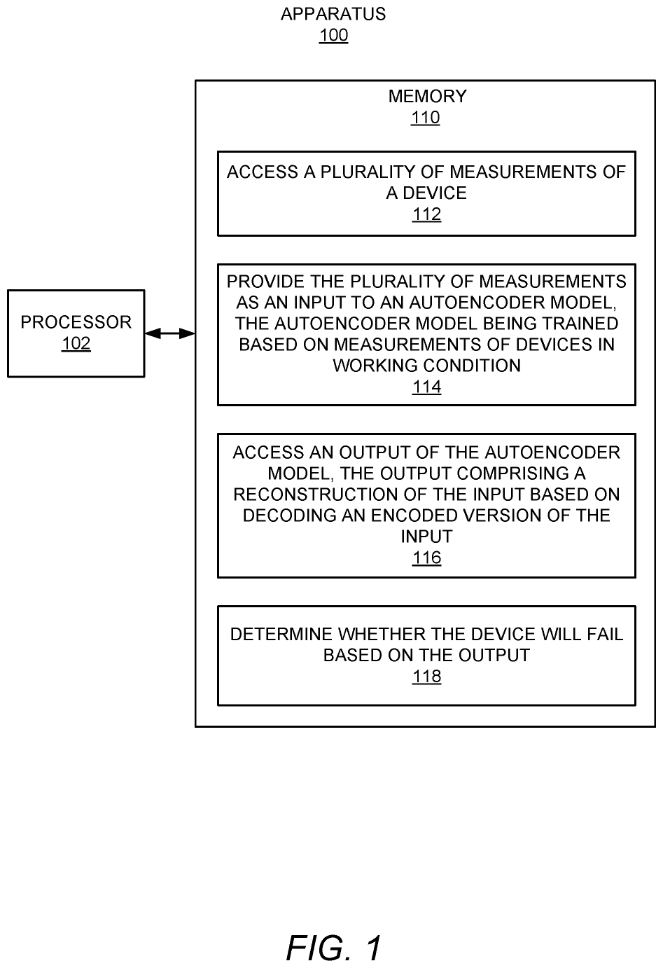

FIG. 1 depicts a block diagram of an example apparatus 100 that determines whether a device will fail based on autoencoders. The apparatus 100 shown in FIG. 1 may be a computing device, a server, a device being tested for failure, and/or other devices. As used herein, the term “tested” or “testing” may refer to accessing measurement data of a device and inputting the measurement data to an autoencoder to determine whether or not the device will fail and/or to determine which device(s) have failed. For example, the testing may be performed prior to any device failure to predict when such failure may occur. In other examples, the testing maybe performed after a malfunction has occurred to diagnose which device has failed. In these examples, a machine may include many devices, each of which may have failed, leading to a malfunction of all or part of the machine. The apparatus 100 may be used to determine which device, if any, in the machine may have failed by accessing measurement data of the devices of the machine. Such accessed measurement data may be stored during operation for such testing.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scope of the apparatus 100 disclosed herein.

The apparatus 100 may include a memory 110 that may have stored thereon machine-readable instructions (which may also be termed computer readable instructions) 112-118 that the processor 102 may execute. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals. It should be understood that the example apparatus 100 depicted in FIG. 1 may include additional features and that some of the features described herein may be removed and/or modified without departing from the scope of the example apparatus 100.

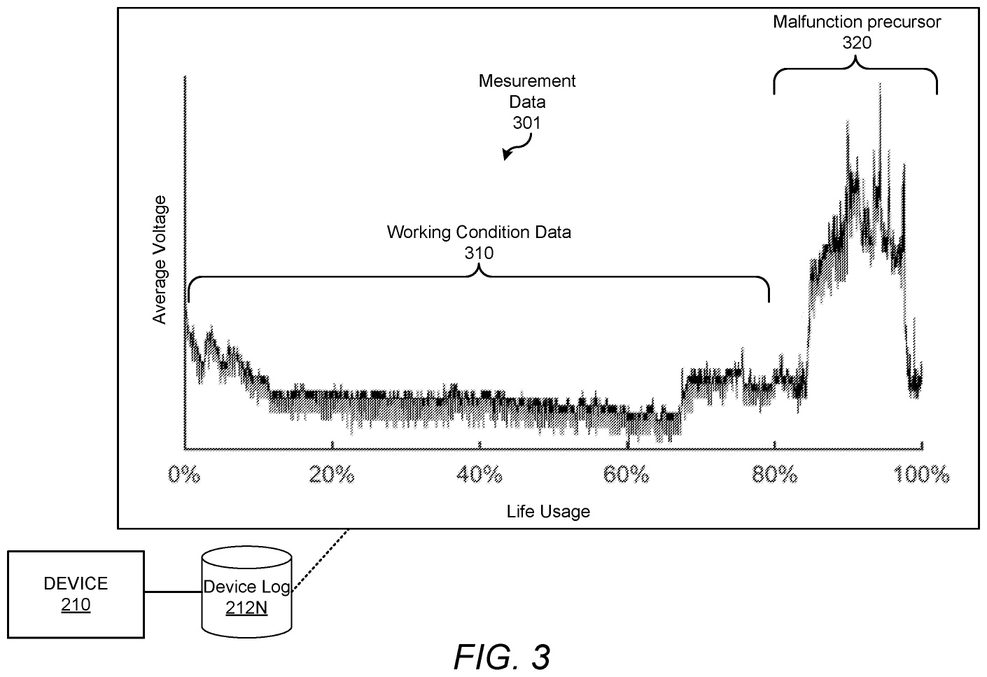

Returning to FIG. 1, the processor 102 may fetch, decode, and execute the instructions 112 to access a plurality of measurements of a device, such as measurement data 301 illustrated in FIG. 3.

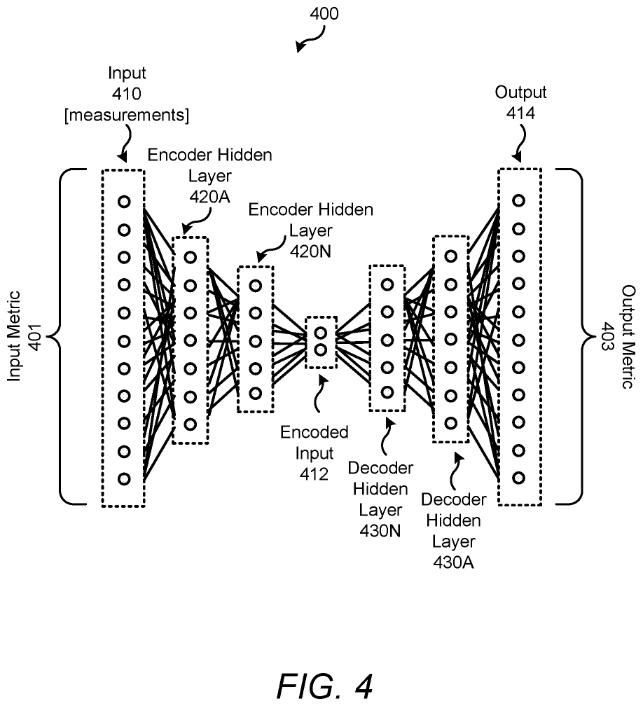

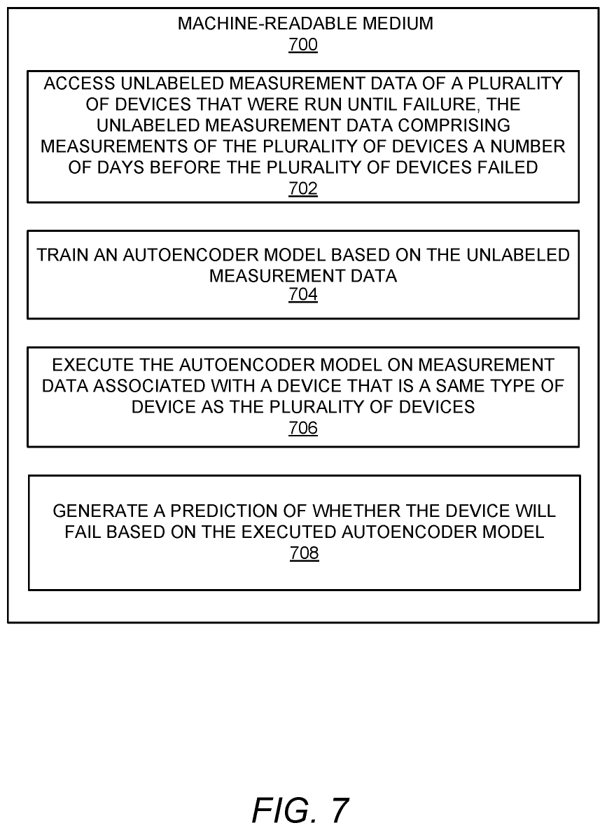

The processor 102 may fetch, decode, and execute the instructions 114 to provide the plurality of measurements (such as measurement data 301) as an input (such as input 410) to an autoencoder (such as the autoencoder 400 illustrated in FIG. 4). The autoencoder may be trained based on measurements of devices in working condition. Such training is described with reference to FIGS. 4 and 7. The processor 102 may fetch, decode, and execute the instructions 116 to access an output, such as an output 414, of the autoencoder. The output may include a reconstruction of the input based on decoding an encoded version of the input.

The processor 102 may fetch, decode, and execute the instructions 118 to determine whether the device will fail based on the output. In some examples, wherein to determine whether the device will fail, the processor 102 may further determine a mean squared error (MSE) of the input and a mean squared error of the output, determine a difference between the mean squared error of the input and the mean squared error of the output, and compare the difference to a threshold difference. The determination of whether the device will fail may be based on the comparison. For example, if the difference exceeds the threshold difference, then the autoencoder may determine that the device will fail.

In some examples, the processor 102 may generate, before the device fails, an alert indicating that the device will fail responsive to the determination that the device will fail. For example, the alert may be communicated to information technology or other personnel, displayed via a graphical user interface such as via the management console 220, and/or otherwise communicated to be acted upon. In some examples, the processor 102 may generate a recommendation to perform maintenance on the device so that the device is serviced prior to failure.

In some examples, processor may further access validation data comprising respective measurements of each of a second plurality of devices that were operated in working condition until failure, provide the validation data as a validation input to the autoencoder, access a validation output of the autoencoder, and determine that a validation device will fail based on the validation input and the validation output, the autoencoder being validated based on the determination that the validation device will fail.

In some examples, the processor 102 may access an amount of time or usage (such as pages printed and/or other usage) that has elapsed between the determination that the validation device will fail and actual failure of the validation device. For example, the processor 102 may determine that 30 days have elapsed or a number of uses since predicting that the validation device will fail and actual failure observed in the validation device (as input to the processor 102 by a user, for example). The processor 102 may generate a validation metric based on the amount of time or the number of uses, and generate a validation report based on the validation metric. The validation metric may include a precision metric and/or a recall metric.

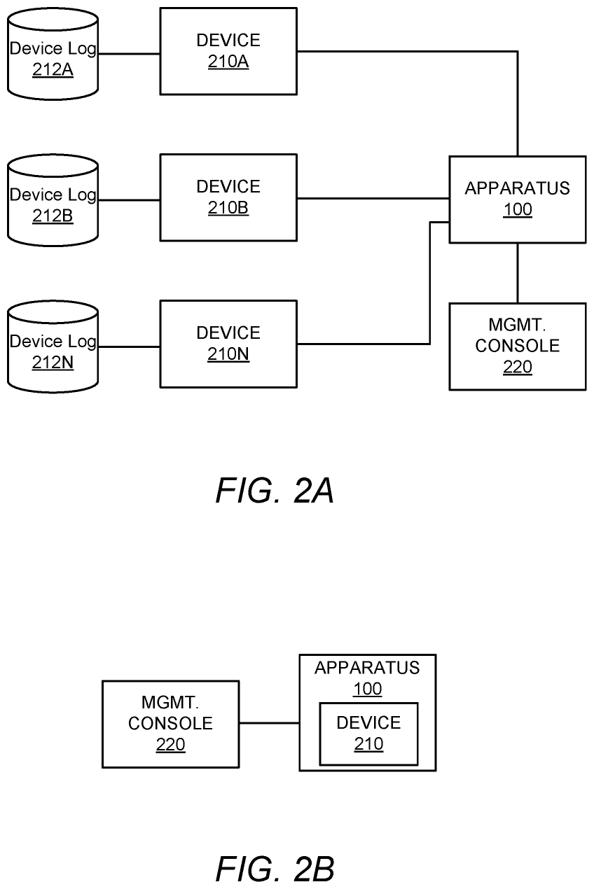

FIGS. 2A and 2B each respectively depict an example architecture of an apparatus to determine whether a device will fail based on autoencoders. Referring to FIG. 2A, each device 210 (illustrated as devices 210A-N) being tested for failure may be coupled to the apparatus 100. In this example, the apparatus 100 may be separate from the devices 210 and may remotely, such as via a network connection like a wide area network or Internet connection, or locally, such as via a local area network or direct connection access respective measurement data, such as from respective device logs 212A-212N. In some of these examples, the apparatus 100 may provide a management console 220 (illustrated as mgmt. console 220). The management console 220 may provide an interface to view results of the testing. For example, the management console 220 may provide the report referenced at FIG. 1. The report may include a listing of managed devices 210 and their predicted failure status, indicating which ones of the devices 210 are predicted to fail. In this manner, maintenance and other personnel may be alerted to predicted failures for proactive mitigation. Alternatively, or additionally, maintenance and other personnel may be alerted to predicted failures to identify already failed devices 210.

Referring to FIG. 2B, the device 210 may be included in the apparatus 100. For example, the apparatus 100 may include a printer and the device 210 may include a printer motor. That is, the apparatus 100 may itself monitor its own measurement data and predict whether or not the device 210 and/or other onboard devices 210 will fail. It should be noted that the apparatus 100 illustrated in FIG. 2A may also be a printer, which monitors other devices 210A-N, which may be part of other printers.

FIG. 3 depicts an example of measurement data 301 of a device 210. In the illustrated example, the measurement data 301 may include average voltage measurements of a device such as a motor of a printer device. The average voltage may be plotted on the Y-axis against the life usage of the motor on the X-axis, in which 100% corresponds to end of life failure. The measurement data 301 may include working condition data 310 and malfunction precursor 320.

It should be noted that the malfunction precursor 320 as illustrated in FIG. 3 may not be as apparent in all examples. The differences between working condition data 310 and malfunction precursor 320 may be subtle but detectable by a trained autoencoder. For example, instead of higher average voltage measurements near the end of life of the device 210, different voltage patterns may be exhibited throughout the lifecycle of the device. Thus, the malfunction precursor 320 need not necessarily occur near the end of life of the device 210.

FIG. 4 depicts an example of a schematic representation of an autoencoder 400. The autoencoder 400 may include an input layer that accepts input 410, one or more encoder hidden layers 420A,N, an encoded input 412, one or more decoder hidden layers 430A,N, and an output layer that generates an output 414, which may be a reconstruction version of the input 410.

Each encoder hidden layer 420 may include a plurality of encoder neurons, or nodes, depicted as circles. Similarly, each decoder hidden layer 430 may include a plurality of decoder neurons, or nodes, depicted as circles. In some examples, each encoder neuron may receive the output of a neuron of a previous encoder hidden layer 420 or the input 410. For example, each encoder neuron in the encoder hidden layer 420A may receive input 410 and output an encoding based on patterns observed in the input 410. Each neuron in the encoder hidden layer 420N may receive a respective encoding from each encoder neuron in the encoder hidden layer 420A, and so forth if further encoder hidden layers are present. The last encoder hidden layer 420 (illustrated in FIG. 4 as encoder hidden layer 420N) may generate an encoded input 412 that is decoded through the one or more decoder hidden layers 430A,N to provide the reconstructed input 414.

In some examples, training and validating the autoencoder 400 may use measurement data 301 obtained from a pool of the devices 210 that were operated until failure. Measurement data 301 from the pool may be split into a set of training devices to be used as “training data” and a set of “validation devices” to be used as “'validation data”. For example, measurement data 301 from 80 percent of the devices 210 in the pool may be allocated for training (“the Training Set”) while 20 percent may be allocated for validation (“the Validation Set”). Other proportional splits may be used as well. The Training Set may include working condition data 310 illustrated in FIG. 3.

In some examples, multiple different autoencoders 400 may be trained. For example, a first autoencoder 400 may be trained on working condition data 310 corresponding to 60% usage. If the first autoencoder 400 determines that the device 210 under test will fail, then the device 210 may be expected to have no more than 40% life usage remaining. Likewise, a second autoencoder 400 may be trained on working condition data 310 corresponding to 70% usage. If the second autoencoder 400 determines that the device 210 under test will fail, then the device 210 may be expected to have no more than 30% life usage remaining, and so on.

Training the autoencoder 400 may include providing a portion of the measurement data 301 from the Training Set as input 410. For example, the autoencoder 400 may be trained on the working condition data 310 of the measurement data 301. In this manner, the processor 102 may train the autoencoder 400 to encode and then decode data representative of a working condition of a device 210 in the Training Set. To obtain the working condition data 310, the (N) number of devices 210 may be operated until failure. During such operation, measurement data 301 may be collected for each of the devices 210. Plot 300 illustrates an example of running a device 210 until failure while collecting measurement data 301 in the form of average voltage usage over time. Other measurement data 301 may be collected in addition or instead of the average voltage usage so long as such measurement data 301 is also used for testing or monitoring a given device 210.

In some examples, the input 410 may be pre-processed prior to training the auto-encoder 400. For example, the processor 102 may smooth, standardize, and/or otherwise pre-process the input 410. To smooth the input 410, the processor 102 may determine a mean of a window of continuous data collection and use the mean to filter out outliers in the measurement data 301. The window of continuous data collection may be selected by a designer such as a data scientist for the training. Such window may be based on a desired range of operation prior to failure. For example, referring to FIG. 3, the window may be set from the start of operation (0%) to a point before failure (such as around 80%). To standardize the input 410, the processor 102 may scale each measurement value to a value between a scaling range. For example, the processor 102 may use a max-min scaler to scale each measurement value to be between a scaling range such as zero and one. In this example, a minimum value in the input 410 may be scaled to zero while a maximum value may be scaled to one, while values in between may be scaled accordingly based on the maximum value. The foregoing scaling may be an appropriate format for input to train the autoencoder 400.

To assess recreation of the input 410, the processor 102 may determine an input metric 401 for the input 410 and an output metric 403 for the output 414, which is a recreation by the autoencoder 400 of the input 410. The input metric 401 may include a mean squared error (MSE) of the measurement values of the input 410. The output metric 403 may include a mean squared error (MSE) of the measurement values of the output 414. A difference between the output metric 403 and the input metric 401 may indicate a level of performance by the autoencoder 400 in recreating the input 410. A smaller difference may indicate that the autoencoder 400 has recreated the input more effectively than if a larger difference resulted.

In some examples, when training the autoencoder 400, a threshold difference may be based on the difference between the output metric 403 and the input metric 401. For example, the threshold difference may be equal to the difference between the output metric 403 and the input metric 401. In some examples, the threshold difference may be equal to the difference between the output metric 403 and the input metric 401 plus or minus a predetermined error value, which may be selected by a user or determined based on a standard error of the distribution of the output 414.

After training, when testing or monitoring measurement data 301 of a device 210, the difference between the output metric 403 and the input metric 401 may be compared to the threshold difference. Deviating from the threshold difference may indicate that the measurement data 301 of the device 210 being tested does not match the working condition data 310 from the Training Set. In some examples, the size of the deviation may be indicative of a greater probability that the device 210 being tested will fail.

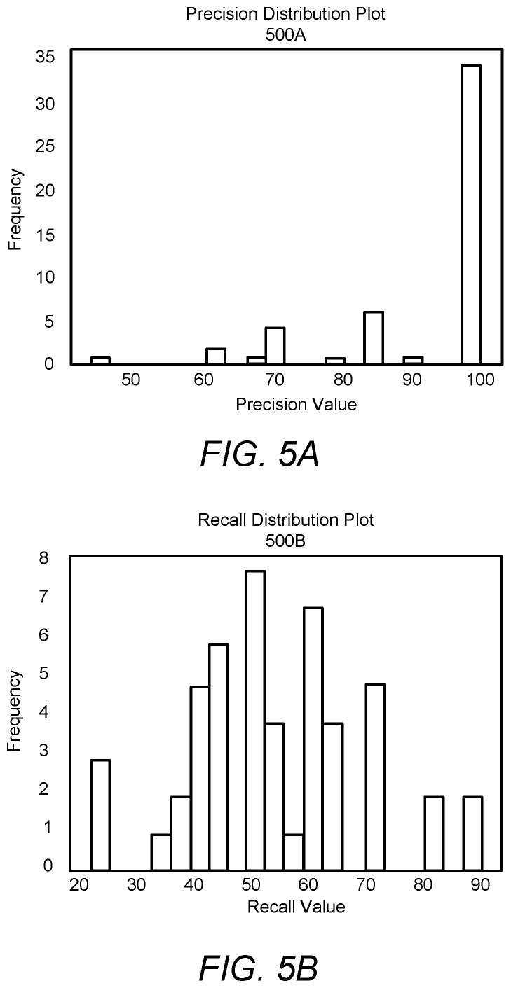

In some examples, the autoencoder 400 may be validated over an (I) number iterations, where I is a number greater than zero. For each iteration, measurement data 301 from the Validation Set may be used as input 410 to the autoencoder 400 for validation. In some examples, at each iteration, measurement data 301 of a portion of the Validation Set may be randomly selected, thereby ensuring random distribution of Validation Set across all of the iterations (I). Post-validation, the processor 102 may generate precision and recall metrics. Examples of such metrics are illustrated by the plots 500A and 500B respectively illustrated in FIGS. 5A and 5B.

Once the autoencoder 400 is trained and validated, the processor 102 may use the autoencoder 400 to make a prediction of whether or not the device 210 being tested will fail. For example, the processor 102 may provide, as input 410 to the autoencoder 400, measurement data 301 of the device 210 being tested. The input 410 may include malfunction precursor 320 depending on whether the device 210 being tested will imminently fail. The input 410 may be encoded by the encoded hidden layers 420(A-N) to generate an encoded input 412. The autoencoder 400 may decode the encoded input 412 through the decoder hidden layers 430(A-N) to generate the output 414. The processor 102 may assess the device 210 under test by generating an input metric 401 of the measurement data 301 and an output metric 403 of the output 414. For example, the input metric 401 may be the MSE of the input 410 and the output metric 403 may be the MSE of the output 414. The processor 102 may determine a difference between the output metric 403 and the input metric 401 and compare the difference to the threshold difference.

In some examples, to avoid predicting failure too early, the processor 102 may use a validation window such that the processor 102 predicts a failure only if multiple tests of the device 210 indicate such failure. For example, the processor 102 may periodically test the device 210 by inputting, at different times, measurement data 301 of the device 210 and count a number of times that the difference between the output metric 403 and the input metric 401 exceeds the threshold difference. When the count exceeds a predetermined threshold number, the processor 102 may determine that the device 210 will fail. In these examples, the processor 102 may generate an alert of such determined failure. Thus, anomalous measurement data from a given test of the device 210 may not trigger a failure device in these examples.

FIG. 5A depicts an example of a precision distribution plot 500A for predictions of whether a device 210 will fail based on autoencoders 400. FIG. 5B depicts an example of a recall distribution plot 500B for predictions of whether a device 210 will fail based on autoencoders 400. Precision and recall may each indicate accuracy of the autoencoder 400. Precision may refer to the percentage of results that are relevant while recall may refer to the percentage of total relevant results correctly predicted to fail.

Table 1 below shows an example of an iteration of validation when using the autoencoder 400 for a predictive model based on days. The precision of 87.5 and the recall of 77.77777777777779 resulted in the example listed in Table 1. The “Device ID” column lists the device 210 identifier and the “delta_to_fail” column shows how many days to actual failure when the prediction was made. For this example, the target may be set at sixty days, such that the autoencoder 400 predicts failure within that target. The devices 210 with “NaN” under the “delta_to_fail” column did not make a prediction before actual failure occurred:

| Device ID | Delta_to_fail |
|---|---|
| 1 | 65 |
| 2 | 3 |
| 3 | NaN |
| 4 | 6 |
| 5 | NaN |
| 6 | 60 |
| 7 | 60- |
| 8 | 52 |
| 9 | 8 |
| 10 | 15 |

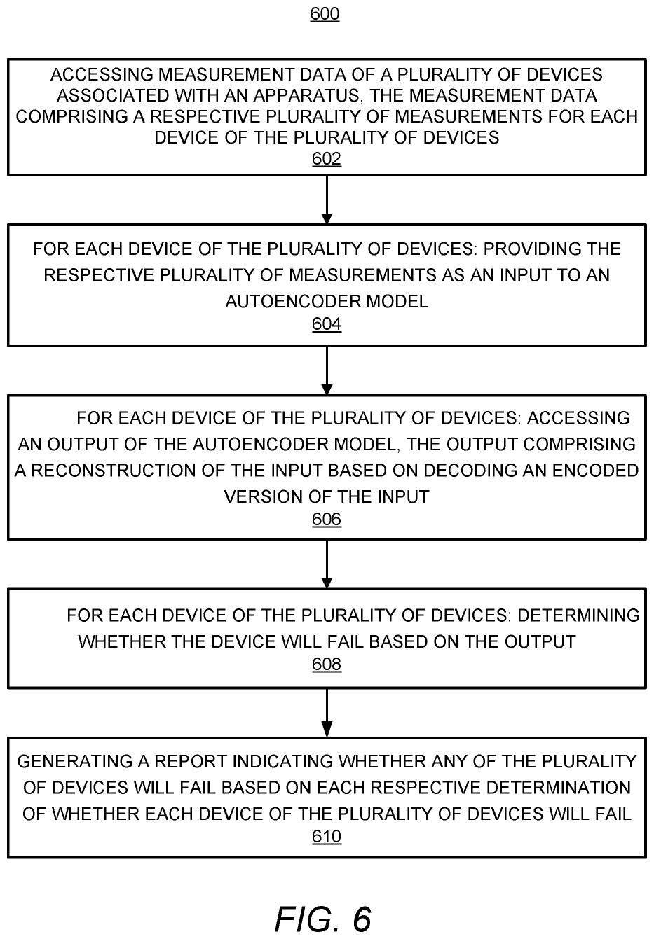

Various manners in which the apparatus 100 may operate to determine whether a device will fail based on autoencoders are discussed in greater detail with respect to the method 600 depicted in FIG. 6. It should be understood that the method 600 may include additional operations and that some of the operations described therein may be removed and/or modified without departing from the scope of the methods. The description of the method 600 may be made with reference to the features depicted in FIGS. 1, 2A, and 2B for purposes of illustration.

FIG. 6 depicts a flow diagram of an example method 600 of determining whether a device will fail based on autoencoders. At block 602, the method 600 may include accessing, by a processor (such as processor 102 illustrated in FIG. 1), measurement data 301 of a plurality of devices (such as devices 210) associated with an apparatus, the measurement data 301 comprising a respective plurality of measurements for each device of the plurality of devices. For example, the plurality of devices 210 may be tested by the apparatus 100. In some examples, the apparatus 100 may test multiple remote devices 210 and/or may test multiple on-board devices 210.

At block 604, the method 600 may include for each device of the plurality of devices: providing the respective plurality of measurements as an input to an autoencoder. At block 606, the method 600 may include for each device of the plurality of devices: accessing an output of the autoencoder, the output comprising a reconstruction of the input based on decoding an encoded version of the input.

At block 608, the method 600 may include for each device of the plurality of devices: determining whether the device will fail based on the output. For example, the report may include an identification of a device, from among the plurality of devices, that will fail. In some examples, the report may be provided via the management console 220 and/or as a pushed alert to personnel. At block 610, the method 600 may include generating a report indicating whether any of the plurality of devices will fail based on each respective determination of whether each device of the plurality of devices will fail.

Some or all of the operations set forth in the method 600 may be included as utilities, programs, or subprograms, in any desired computer accessible medium. In addition, the method 600 may be embodied by computer programs, which may exist in a variety of forms. For example, some operations of the method 600 may exist as machine-readable instructions, including source code, object code, executable code or other formats. Any of the above may be embodied on a non-transitory machine-readable (such as computer-readable) storage medium. Examples of non-transitory machine-readable storage media include computer system RAM, ROM, EPROM, EEPROM, and magnetic or optical disks or tapes. It is therefore to be understood that any electronic device capable of executing the above-described functions may perform those functions enumerated above.

FIG. 7 depicts a block diagram of an example non-transitory machine-readable storage medium 700 of training an autoencoder to predict whether a device will fail. The machine-readable instructions 702 may cause the processor (such as processor 102 illustrated in FIG. 1) to access unlabeled measurement data 301 of a plurality of devices that were run until failure, the unlabeled measurement data 301 comprising measurements of the plurality of devices a number of days before the plurality of devices failed.

In some examples, the processor may be caused to pre-process the unlabeled measurement data 301. For example, to pre-process the unlabeled measurement data 301, the processor may be caused to determine a mean of the unlabeled measurement data 301, and smooth the unlabeled measurement data 301 based on the mean to remove outliers from the unlabeled measurement data 301. In some examples, to pre-process the unlabeled measurement data 301, the processor may be further caused to scale each of value of the smoothed unlabeled data to standardize the smoothed unlabeled data for training

The machine-readable instructions 704 may cause the processor to train an autoencoder based on the unlabeled measurement data 301. The machine-readable instructions 706 may cause the processor to execute the autoencoder on measurement data 301 associated with a device that is a same type of device as the plurality of devices. The machine-readable instructions 708 may cause the processor to generate a prediction of whether the device will fail based on the executed autoencoder.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory machine-readable medium on which is stored instructions that when executed by the processor, cause the processor to:
access a plurality of measurements of a device;
provide the plurality of measurements as an input to an autoencoder, the autoencoder being trained based on measurements of devices in working condition;
access an output of the autoencoder, the output comprising a reconstruction of the input based on decoding an encoded version of the input; and
determine whether the device will fail based on the output.

2. The apparatus of claim 1, wherein to determine whether the device will fail, the instructions further cause the processor to:
determine a mean squared error of the input and a mean squared error of the output;
determine a difference between the mean squared error of the input and the mean squared error of the output; and
compare the difference to a threshold difference, wherein the determination of whether the device will fail is based on the comparison.

3. The apparatus of claim 2, wherein to determine whether the device will fail, the instructions further cause the processor to:
determine that the difference exceeds the threshold difference; and
determine that the device will fail based on the determination that the difference exceeds the threshold difference.

4. The apparatus of claim 3, wherein the instructions further cause the processor to:
generate, before the device fails, an alert indicating that the device will fail responsive to the determination that the device will fail.

5. The apparatus of claim 4, wherein to generate the alert, the instructions further cause the processor to:
generate a recommendation to perform maintenance on the device.

6. The apparatus of claim 3, wherein to determine whether the device will fail, the instructions further cause the processor to:
determine a number of times that the autoencoder determined that the device will fail; and
generate an alert that the device will fail when the number of times meets or exceeds a threshold number.

7. The apparatus of claim 1, wherein the instructions further cause the processor to:
access training data comprising respective measurements of each of a plurality of devices in working condition that were operated until failure; and
train the autoencoder based on the training data.

8. The apparatus of claim 7, wherein the instructions further cause the processor to:
access validation data comprising respective measurements of each of a second plurality of devices that were operated in working condition until failure;
provide the validation data as a validation input to the autoencoder;
access a validation output of the autoencoder; and
determine that a validation device will fail based on the validation input and the validation output, the autoencoder being validated based on the determination that the validation device will fail.

9. The apparatus of claim 8, wherein the instructions further cause the processor to:
access an amount of time that has elapsed between the determination that the validation device will fail and actual failure of the validation device;
generate a validation metric based on the amount of time; and
generate a validation report based on the validation metric.

10. The apparatus of claim 1, wherein the apparatus comprises a printer, the device comprises a printer motor and the plurality of measurements comprise a measurement of the printer motor over time.

11. The apparatus of claim 1, wherein the device comprises a printer motor of a printer and the apparatus comprises a server device, and wherein the instructions further program the apparatus to:
receive the measurement data from the printer via a network.

12. A method, comprising:
accessing, by a processor, measurement data of a plurality of devices associated with an apparatus, the measurement data comprising a respective plurality of measurements for each device of the plurality of devices;
for each device of the plurality of devices:
providing, by the processor, the respective plurality of measurements as an input to an autoencoder;
accessing, by the processor, an output of the autoencoder, the output comprising a reconstruction of the input based on decoding an encoded version of the input;
determining, by the processor, whether the device will fail based on the output; and
generating, by the processor, a report indicating whether any of the plurality of devices will fail based on each respective determination of whether each device of the plurality of devices will fail.

13. The method of claim 12, wherein determining whether the device will fail comprises:
determining a mean squared error of the input and a mean squared error of the output;
determining a difference between the mean squared error of the input and the mean squared error of the output;
determining that the difference exceeds a threshold difference; and
determining that the device will fail based on the determination that the difference exceeds the threshold difference.

14. A non-transitory machine-readable medium on which is stored machine-readable instructions that when executed by a processor, cause the processor to:
access unlabeled measurement data of a plurality of devices that were run until failure, the unlabeled measurement data comprising measurements of the plurality of devices a number of days before the plurality of devices failed;
train an autoencoder based on the unlabeled measurement data;
execute the autoencoder on measurement data associated with a device that is a same type of device as the plurality of devices; and
generate a prediction of whether the device will fail based on the executed autoencoder.

15. The non-transitory machine-readable medium of claim 14, wherein the instructions when executed further cause the processor to:
determine a mean of the unlabeled measurement data; and
smooth the unlabeled measurement data based on the mean to remove outliers from the unlabeled measurement data.
